(19) United States
(12) Patent Application Publication
(10) Pub. No.: US 2013/0255642 A1
(43) Pub. Date: Oct. 3, 2013

(54) SYSTEM FOR MEASURING PROPERTIES OF FUEL

(71) Applicant: ASIAN KOGYO KABUSHIKI KAISHA, Aichi-ken (JP)

(72) Inventor: Masaki Ikeya, Aichi-ken (JP)

(73) Assignee: AISAN KOGYO KABUSHIKI KAISHA, Aichi-ken (JP)

(21) Appl. No.: 13/845,386

(22) Filed: Mar. 18, 2013

(30) Foreign Application Priority Data
Mar. 30, 2012 (JP) 2012-081913

(51) Int. Cl. F02D 41/24

(52) U.S. Cl. CPC F02D 41/24
USPC 123/494

(57) ABSTRACT

A system configured to measure properties of fuel in a fuel tank includes a first measuring device configured to measure a first property of the fuel, a second measuring device configured to measure a second property of the fuel, and a processor connected to the first and second measuring devices. The processor is capable of communicating with a control device that controls an internal combustion engine to which the fuel in the fuel tank is supplied. The processor outputs first signals, a second signal, or both the first and second signals, the first signals indicating a first result measured by the first measuring device and a second result measured by the second measuring device, and the second signal being obtained by processing the first and second results.

### CROSS-REFERENCE TO RELATED APPLICATION

This application claims priority to Japanese Patent Application No. 2012-081913 filed on Mar. 30, 2012, the contents of which are hereby incorporated by reference into the present application.

### TECHNICAL FIELD

The present teachings relate to a system for measuring properties of fuel.

### DESCRIPTION OF RELATED ART

Generally, in vehicles such as automobiles, fuel in a fuel tank is supplied to an internal combustion engine and the fuel is burned in the internal combustion engine. In order to, for example, adequately burn the fuel in the internal combustion engine, it is necessary to measure properties of fuel in the fuel tank. To this end, a measuring device for measuring properties of fuel in the fuel tank has been developed (e.g., Japanese Patent Application Publication No. 2009-79555).

### BRIEF SUMMARY

There is a case in that a plurality of measuring devices for measuring properties of fuel is provided in a fuel tank. In this case, in a conventional technique, a processer is provided for every measuring device, and a measurement result is transmitted from each processor to a control device (e.g., an engine ECU, etc.) for controlling an internal combustion engine. Accordingly, there is a problem in that a processor and communication means are required for every measuring device, which complicates a device structure. In the specification, there is provided a technique which makes it possible, when there is a plurality of measuring devices for measuring properties of fuel, to transmit results measured by respective measuring devices to a control device for controlling an internal combustion engine with a simple device structure.

A system configured to measure properties of fuel disclosed in the specification comprises a first measuring device configured to measure a first property of the fuel in the fuel tank, a second measuring device configured to measure a second property of the fuel in the fuel tank, and a processor connected to the first and second measuring devices. The processor is capable of communicating with a control device that controls an internal combustion engine to which the fuel in the fuel tank is supplied. The processor outputs first signals, a second signal, or both the first and second signals, the first signals indicating a first result measured by the first measuring device and a second result measured by the second measuring device, and the second signal being obtained by processing the first and second results.

In the above system, the results measured by the first measuring device and the second measuring device are input to the processor, and the first results and/or the second result are output to the control device (i.e., control device that controls the internal combustion engine) from the processor. That is, the processor is not provided for every measuring device, and the results are transmitted by one processor. Accordingly, the results measured by the respective measuring devices can be transmitted to the control device with a simple device structure.

### BRIEF DESCRIPTION OF DRAWINGS

FIG. 1 shows a configuration of a system of measuring properties of fuel according to a first embodiment.

FIG. 2 is a block diagram showing a configuration of a processor.

FIG. 3 shows a configuration of a system of measuring properties of fuel according to a second embodiment.

FIG. 4 shows a configuration of a system of measuring properties of fuel according to a third embodiment.

FIG. 5 shows a configuration of a system of measuring properties of fuel according to a fourth embodiment.

### DETAILED DESCRIPTION OF EMBODIMENTS

In one aspect of the present teachings, a processor of the system configured to measure properties of fuel as disclosed herein may convert a first result inputted by a first measuring device and a second result inputted by a second measuring device to serial signals, and output the serial signals to a control device. According to this configuration, a plurality of pieces of information (i.e., the first result and the second result) can be output to the control device via one communication line.

In another aspect of the present teachings, the processor of the system of measuring properties of fuel may include a power control unit adapted to connect to an external power source, and the power control unit may control power supplied from the external power source according to an order from the control device, and supply the controlled power to a fuel pump. Furthermore, the processor may include a power unit configured to supply the power supplied from the external power source to the first and second measuring devices. According to this configuration, as compared with a configuration in which power is directly supplied from the external power source to the first measuring device and the second measuring device, the power from the external power source simply needs to be supplied to the processor. As a result, the number of power lines for connecting the external power source and the system of measuring properties of fuel can be reduced.

In another aspect of the present teachings, the first measuring device may be disposed at a first position in the fuel tank. The second measuring device may be disposed at a second position in the fuel tank, and the first and second properties may be a same property. In this case, the processor may determine based on the first result inputted by the first measuring device and the second result inputted by the second measuring device whether one or both of the first and second measuring devices are operating abnormally or not. According to this configuration, the first result and the second result of the same property are input to one processor, so that the processor may have a function of determining whether one of or both of the first and second measuring devices are operating abnormally or not.

In another aspect of the present teachings, the processor may further correct one of or both of the first and second results based on the first result inputted by the first measuring device and the second result inputted by the second measuring device. According to this configuration, the first result and the second result of the same fuel property are input to one processor, so that the processor may have a function of correcting one of the results by using the other one of the results.

In another aspect of the present teachings, the processor may be disposed at a predetermined position of the fuel tank. Furthermore, one of or both of the first and second measuring devices may be disposed at positions different from the predetermined position. In this case, the processor may be connected to the one of or both of the first and the second measuring devices disposed at the different positions via a drive shield line. According to this configuration, generation of parasitic capacitance due to a communication line for connecting the processor and the measuring device can be restrained to enhance measurement accuracy.

### First Embodiment

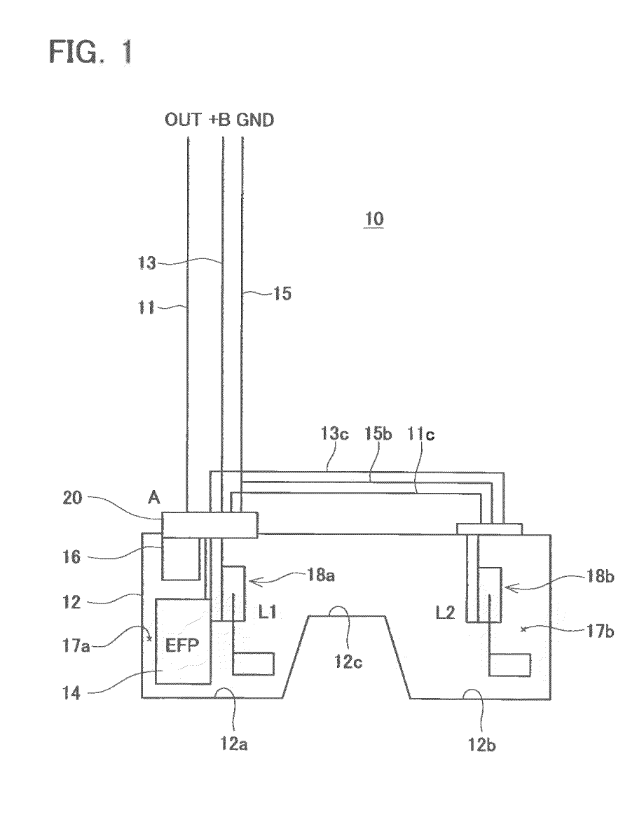

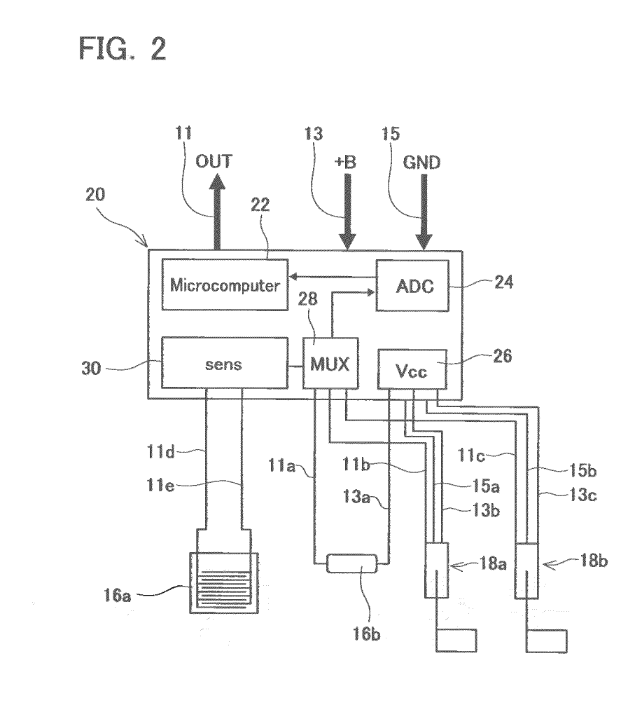

As shown in FIG. 1, a system 10 of measuring properties of fuel is disposed to a fuel tank 12 having a saddle structure mounted on an automobile. As shown in FIGS. 1 and 2, the system 10 configured to measure properties of fuel is equipped with a fuel property measuring device 16, a first liquid level measuring device 18a, a second liquid level measuring device 18b, and a tank ECU 20 connected to the measuring devices 16, 18a, and 18b.

First, the fuel tank 12 having a saddle structure to which the system 10 for measuring properties of fuel is disposed will be described. In a tank bottom surface of the fuel tank 12, a center part 12c thereof is projected upward with respect to an end part 12a on one side and an end part 12b on the other side. Accordingly, a first fuel chamber 17a is formed on the one side of the fuel tank 12, and a second fuel chamber 17b is formed on the other side of the fuel tank 12. The first fuel chamber 17a and the second fuel chamber 17b arc separated by the center part 12c of the tank bottom surface. Consequently, when amount of the fuel stored in the fuel tank 12 is reduced (that is, when liquid level of the fuel is lowered), the fuel is stored in each of the first fuel chamber 17a and the second fuel chamber 17b. As a result, total amount of the fuel stored in the fuel tank 12 cannot be accurately calculated by measuring only the liquid level of the first fuel chamber 17a. Likewise, total amount of the fuel stored in the fuel tank 12 cannot be accurately calculated by measuring only liquid level of the second fuel chamber 17b. Therefore, in the embodiment, as described below, both of the liquid level of the fuel in the first fuel chamber 17a and the liquid level of the fuel in the second fuel chamber 17b are measured.

A fuel pump 14 (denoted as “EFP” in the drawings) is disposed in the first fuel chamber 17a of the fuel tank 12. The fuel pump 14 absorbs the fuel in the fuel tank 12 (in particular, in the first fuel chamber 17a) and applies pressure, and supplies the pressurized fuel to an external an engine) of the fuel tank 12. The fuel pump 14 is connected to the tank ECU 20. The fuel pump 14 operates by power (e.g., power of +12 V) supplied from the tank ECU 20. Note that, since the fuel pump 14 is disposed in the first fuel chamber 17a, when the liquid level of the fuel in the fuel tank 12 is lowered, it is necessary to transfer the fuel in the second fuel chamber 17b into the first fuel chamber 17a. The transfer of the fuel from the second fuel chamber 17b to the first fuel chamber 17a is to be performed by acceleration and deceleration during traveling or centrifugal force during turning, or is to be performed by a jet pump (not shown) that uses some of the fuel ejected from the fuel pump 14.

The fuel property measuring device 16 is disposed on an upper surface of the fuel tank 12 (to be more specific, on upper surface of the fuel tank 12 on the side of the first fuel chamber 17a), and is located in the fuel tank 12. The fuel property measuring device 16 includes a case and sensor units 16a and 16b (shown in FIG. 2) housed in the case. Some of the fuel ejected from the fuel pump 14 is supplied in the case of the fuel property measuring device 16. For example, fuel from a pressure regulator (not shown) for adjusting a pressure of the fuel ejected from the fuel pump 14 is supplied in the ease. Accordingly, when the fuel pump 14 is operated, fuel is supplied in the case, and the fuel become in contact with the sensor units 16a and 16b of the fuel property measuring device 16. The fuel supplied in the case is returned in the fuel tank 12 from a discharge port (not shown) formed in the case.

As shown in FIG. 2, the sensor units 16a and 16b of the fuel property measuring device 16 includes a fuel liquid quality measuring unit 16a for measuring a liquid quality of the fuel and a fuel temperature measuring unit 16b for measuring temperature of the fuel. The fuel liquid quality measuring unit 16a is a sensor of a capacitance type equipped with a pair of comb-shaped electrodes opposing to each other. When a liquid quality of the fuel in the case is changed, the capacitance between the pair of electrodes of the fuel liquid quality measuring unit 16a is changed. The fuel liquid quality measuring unit 16a enables to specify a liquid quality of the fuel (e.g., concentration of ethanol included in the fuel, etc.) by measuring the change of the capacitance. The fuel temperature measuring unit 16b is a sensor of a resistance type such as a thermistor. The fuel temperature measuring unit 16b detects temperature of the fuel supplied from the fuel pump 14 to the fuel property measuring device 16.

As shown in FIG. 1, the first liquid level measuring device 18a is attached on an upper surface of the fuel tank 12 (upper surface of the fuel tank 12 on the side of the first fuel chamber 17a), and is disposed in the first fuel chamber 17a. The first liquid level measuring device 18a is a sensor gauge for measuring a liquid level of the fuel in the first fuel chamber 17a. The first liquid level measuring device 18a includes a housing, an arm attached to the housing in a pivotable manner, and a float attached to a distal end of the arm. When the liquid level of the fuel in the first fuel chamber 17a is changed, a height of the float is changed, which changes an angle of the arm. When the angle of the arm is changed, the angle of the arm is detected by a magnetic detecting element housed in the housing. The liquid level of the fuel in the first fuel chamber 17a can be specified by the angle of the arm detected by the magnetic detecting element.

The second liquid level measuring device 18b is attached on an upper surface of the fuel tank 12 (i.e., an upper surface of the fuel tank 12 on the side of the second fuel chamber 17b) and is disposed in the second fuel chamber 17b. The second liquid level measuring device 18b is a sensor gauge for measuring a liquid level of the fuel in the second fuel chamber 17b. The second liquid level measuring device 18b has a same structure as that of the first liquid level measuring device 18a. Note that, a sensor gauge of a resistance type may be used for each of the liquid level measuring devices 18a and 18b instead of the sensor gauge using a magnetic detecting element.

As shown in FIG. 1, the tank ECU 20 is disposed on an upper surface of the fuel tank 12 (to be more specific, an upper surface of the fuel tank 12 on the side of the first fuel chamber 17a). The tank ECU 20 is connected to an engine ECU (not shown) by a signal line 11, and is connected to an external power source over of +12 V) by a power line 13, and is grounded by a ground line 15. Furthermore, the tank ECU 20 is connected to the fuel liquid quality measuring unit 16a and the fuel temperature measuring unit 16b of the fuel property measuring device 16, the first liquid level measuring device 18a, and the second liquid level measuring device 18b.

As shown in FIG. 2, the tank ECU 20 is equipped with a microcomputer 22, an AD convertor 24 (denoted as “ADC”), a power circuit 26 (denoted as “Vcc”), a multiplexer 28 (denoted as “MUX”), and a detecting circuit 30 (denoted as “sens”). The microcomputer 22 is equipped with a CPU, a ROM, a RAM, etc. As described below, the microcomputer 22 performs processing of a signal input from the measuring devices (16a, 16b), 18a and 18b, communication processing with the engine ECU, fault diagnosis of the fuel liquid quality measuring device 16, the liquid level measuring devices 18a and 18b, the detecting circuit 30, and the tank ECU 20 itself, etc.

The power circuit 26 generates sensor power (+5 V) from the power (+12 V) supplied from the external power source via the power line 13. The fuel temperature measuring unit 16b, the first liquid level measuring device 18a, and the second liquid level measuring device 18b are connected to the power circuit 26 via power lines 13a, 13b, and 13c, respectively. The sensor power (+5 V) is supplied to the fuel temperature measuring unit 16b, the first liquid level measuring device 18a, and the second liquid level measuring device 18b from the power circuit 26. Note that the power (+12 V) supplied to the tank ECU 20 via the power line 13 is directly supplied to the fuel pump 14 or supplied to the fuel pump 14 by a PWM control performed by the microcomputer 22 so that the fuel pump 14 becomes a predetermined rotation number according to an order from the engine ECU. That is, in the embodiment, the microcomputer 22 may have a function as a power control unit for controlling the power supplied from the external power source and supplying the controlled power to the fuel pump 14.

The detecting circuit 30 is connected the pair of electrodes of the fuel liquid quality measuring unit 16a by signal lines 11d and 11e. The detecting circuit 30 outputs an alternate current signal to one of the signal lines 11d and 11e, and grounds the other one of the signal lines 11d and 11e. Herewith, a signal according to a liquid quality such as capacitance between the pair of electrodes of the fuel liquid quality measuring unit 16a or electric conductivity of the fuel is input to the detecting circuit 30. The signal input to the detecting circuit 30 is input to the multiplexer 28.

The multiplexer 28 is connected to the fuel temperature measuring unit 16b, the first liquid level measuring device 18a, and the second liquid level measuring device 18b by signal lines 11a, 11b, and 11c, respectively. Accordingly, a signal from the fuel temperature measuring unit 16b is input to the multiplexer 28, a signal from the first liquid level measuring device 18a is input to the multiplexer 28, and a signal from the second liquid level measuring device 18b is input to the multiplexer 28. Furthermore, as described above, the signal from the fuel liquid quality measuring unit 16a is also input to the multiplexer 28 via the detecting circuit 30. The multiplexer 28 generates one signal from the input signals and inputs the generated signal to the AD convertor 24. The AD convertor 24 converts the signal (analog signal) input from the multiplexer 28 into a digital signal and input the converted signal to the microcomputer 22.

A drive shield line is used for the signal line 11c connecting the second liquid level measuring device 18b and the tank ECU 20. This is due to the reason to be described below. The second liquid level measuring device 18b is disposed on the side of the second fuel chamber 17b, and the tank ECU 20 is disposed on the side of the first fuel chamber 17a. Accordingly, the signal line 11c is a relatively long signal line, which may easily generate parasitic capacitance. Therefore, the generation of parasitic capacitance is restrained by using a drive shield line for the signal line 11c. Herewith, accuracy of measuring the liquid level by the second liquid level measuring device 18b is enhanced. Note that the second liquid level measuring device 18b is connected to the tank ECU 20 by a ground line 15b for ground, and the first liquid level measuring device 18a is also connected to the ECU 20 by a ground line 15a for ground.

Next, processing performed by the microcomputer 22 of the tank ECU 20 will be described in detail. The signals from the fuel liquid quality measuring unit 16a, the fuel temperature measuring unit 16b, the first liquid level measuring device 18a, and the second liquid level measuring device 18b is input to the microcomputer 22 via the multiplexer 28 and the AD convertor 24. The microcomputer 22 processes the signals and performs processing described below.

(1) Fuel Property Specification Processing

The microcomputer 22 specifies the capacitance between the pair of electrodes (which is changed by liquid quality of the fuel) based on the signal input from the fuel liquid quality measuring unit 16a. Furthermore, the microcomputer 22 specifies the temperature of the fuel based on the signal input from the fuel temperature measuring unit 16b. As described above, the capacitance between the pair of electrodes of the fuel liquid quality measuring omit 16a is changed by liquid quality of the fuel (for example, concentration of ethanol included in the fuel). Furthermore, the capacitance between the pair of electrodes is changed also by the temperature of the fuel. Accordingly, the microcomputer 22 specifies the liquid quality of the fuel by using the specified capacitance between the pair of the electrodes and the specified temperature of the fuel. It is also possible to measure electric conductivity of the fuel by the fuel liquid quality measuring unit 16a to specify the liquid quality of the fuel. For example, the microcomputer 22 specifies the concentration of the ethanol in the fuel by using as database showing relationship of “capacitance”, “temperature of the fuel”, and “concentration of the ethanol” which are memorized in the microcomputer 22.

(2) Processing of Calculating Fuel Storage Quantity

The microcomputer 22 specifies a liquid level of the fuel in the first fuel chamber 17a based on the signal input by the first liquid level measuring device 18a. Likewise, the microcomputer 22 specifies a liquid level of the fuel in the second fuel chamber 17b based on the signal input by the second liquid level measuring device 18b. Furthermore, the microcomputer 22 corrects respective values measured by the liquid level measuring devices 18a and 18b, and corrects respective measurement values depending on shapes in the fuel chambers 17a and 17b. When the liquid level of the fuel in the first fuel chamber 17a and the liquid level of the fuel in the second fuel chamber 17b are specified, the microcomputer 22 calculates fuel storage quantity in the fuel tank 12 based on the values.

(3) Fault Diagnosis—Property Correction Processing

When a lot of fuel is stored in the fuel tank 12 (for example, right after fed in the fuel tank 12), the liquid level of the fuel in the first fuel chamber 17a becomes same as the liquid level of the fuel in the second fuel chamber 17b. Accordingly, supposing a lot of fuel is stored in the fuel tank 12, when the liquid level specified according to the signal input by the first liquid level measuring device 18a and the liquid level specified according to the signal input by the second liquid level measuring device 18b are different, the microcomputer 22 corrects the signal output by the liquid level measuring device 18a or 18b so that the liquid levels become same. Herewith, one of the signals output by the first liquid level measuring device 18a and the second liquid level measuring device 18b is corrected, so that the fuel stored in the fuel tank 12 can be calculated with accuracy.

Note that there is a case in that the liquid level specified according to the signal input by the first liquid level measuring device 18a and the liquid level specified according to the signal input by the second liquid level measuring device 18b become different as time advances even after the above correction processing is performed. Furthermore, there is a case in that the liquid level specified according to the signal input by the first liquid level measuring device 18a and the liquid level specified according to the signal input by the second liquid level measuring device 18b are largely different. In the cases, it is considered that one of or both of the first liquid level measuring device 18a and the second liquid level measuring device 18b is operating abnormally. Furthermore, it is considered that the liquid level measuring devices 18a and 18b are operating abnormally also when outputs from the first liquid level measuring device 18a and/or the second liquid level measuring device 18b are not in as prescribed range. Accordingly, when the cases occur, the microcomputer 22 determines that the first liquid level measuring device 18a and/or the second liquid level measuring device 18b is operating abnormally. This enables to prevent that the fuel storage quantity is calculated based on the liquid level measuring devices 18a and 18b operating abnormally.

(4) Signal Output Processing

The microcomputer 22 performs processing for outputting fuel properties (that is, liquid quality of the fuel (for example, concentration of ethanol in the fuel), temperature of the fuel, fuel storage quantity) specified by the processing of the above-mentioned (1) and (2) to the engine ECU. Specifically, the microcomputer 22 generates a serial signal indicating the fuel properties every predetermined cycle, and output the generated serial signal to the engine ECU via the signal line 11. This enables the engine ECU to perform adequate control (control of amount of fuel ejection, control of ignition timing, control of rotation number of the fuel pump, etc.) depending on the properties of the fuel to be supplied to the engine from the fuel pump 14. Furthermore, since fuel consumption is changed depending on the fuel properties (liquid quality of the fuel, etc.), it becomes possible for the engine ECU to accurately calculate a remaining travelable distance based on the fuel properties transmitted from the microcomputer 22 and display the distance. Note that, when it is determined that the first liquid level measuring device 18a and/or the second liquid level measuring device 18b is operating abnormally in the above-mentioned processing (3), the microcomputer 22 outputs a failure signal to the engine ECU via the signal line 11. This enables the engine ECU to recognize that the liquid level measuring devices 18a and 18b are operating abnormally, which enables to notify a user of the failure.

As described above, in the system 10 of measuring properties of fuel according to the embodiment, the measuring devices 16, 18a, and 18b for measuring respective fuel properties are connected to one tank ECU 20, and signals are to be output to the engine ECU from the tank ECU 20. Accordingly, a processor (that is, signal output circuit, etc.) becomes unnecessary for every measuring device, and a wire (harness) for communication for connecting the respective processor and the engine ECU becomes also unnecessary. Therefore, in the system 10 of measuring properties of fuel according to the embodiment, results measured by respective measuring devices 16, 18a, and 18b can be output outside with a simple configuration.

Furthermore, in the system 10 of measuring properties of fuel according to the embodiment, only the power (+12 V) fur the fuel pump 14 is supplied to the tank ECU 20 from outside, and the power (+5 V) for the sensors is generated by the tank ECU 20 to supply the power (+5 V) for the sensors to each of the measuring devices 16, 18a, and 18b. Accordingly, the number of wirings (harnesses) for power can be reduced as compared with a configuration in which power (+5 V) for sensor is supplied to each measuring device from outside.

Finally, a correspondence relationship between the above embodiment and claims will be described. Any of the fuel property measuring device 16, the first liquid level measuring device 18a, and the second liquid level measuring device 18b is an example of “a first measuring device” described in claims, another device other than “the first measuring device” among the fuel property measuring device 16, the first liquid level measuring device 18a, and the second liquid level measuring device 18b is an example of “a second measuring device” described in the claims, and the tank ECU 20 is an example of “a processor” described in the claims.

While the system for measuring properties of fuel of the present embodiment has been described above in detail, the example is merely illustrative and places no limitation on the scope of the patent claims. The technology described in the patent claims also encompasses various changes and modifications to the specific example described above.

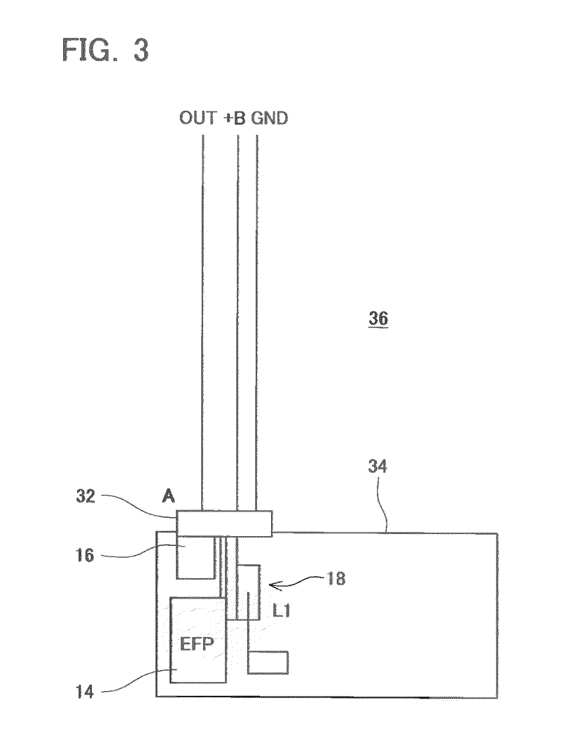

For example, in the above embodiment, a system of measuring properties of fuel disposed to the fuel tank 12 having a saddle shape is described, but the technology disclosed in the specification is not limited to such an example. For example, as shown in FIG. 3, the technology may be applied to a fuel tank 34 whose tank bottom surface is formed in a flat surface shape. In this case, a system 36 of measuring properties of fuel is configured by a tank ECU 32, a fuel property measuring device 16 and one liquid level measuring device 18. Also in this case, a signal from the fuel property measuring device 16 and a signal from the liquid level measuring device 18 are input to the tank ECU 32, and is output to an engine ECU as a serial signal from the tank ECU 32. Also with the configuration, it is possible to output the signals from the respective measuring devices 16 and 18 to the engine ECU with a simple configuration. Note that in a second embodiment shown in FIG. 3, the fuel property measuring device 16 is an example of “a first measuring device” described in Claim 1, and the liquid level measuring device 18 is an example of “a second measuring device” described in Claim 1.

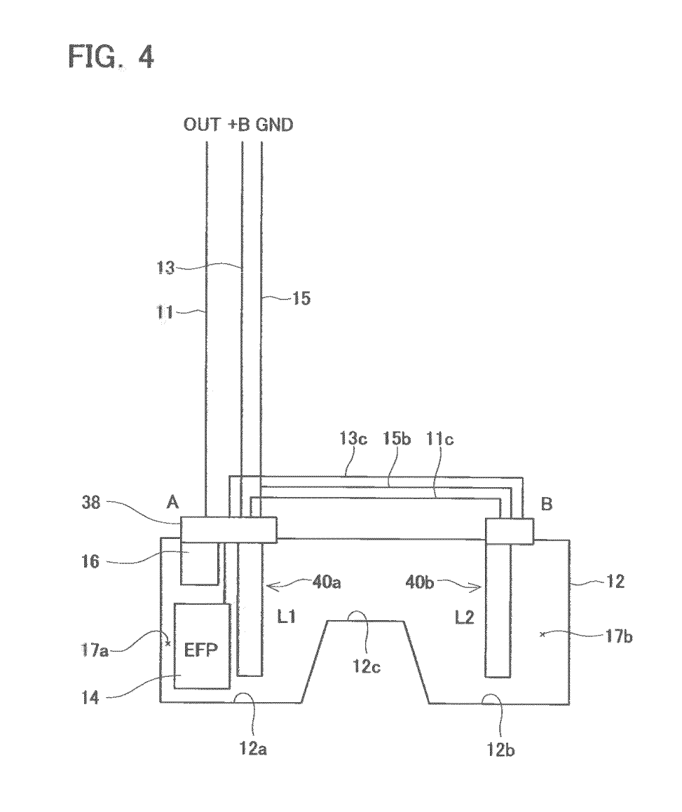

Alternatively, a system of measuring properties of fuel as shown in FIG. 4 may be employed in which a liquid level sensor of a capacitance type is used for a measuring device 40a for measuring a liquid level of a first fuel chamber 17a, and a liquid level sensor of a capacitance type is used for a measuring device 40b for measuring a liquid level of a second fuel chamber 17b. Also in this ease, signals from the respective measuring devices 16, 40a, and 40b are input to a detection circuit of a tank ECU 38, and processing similar to the above embodiment is performed in the tank ECU 38.

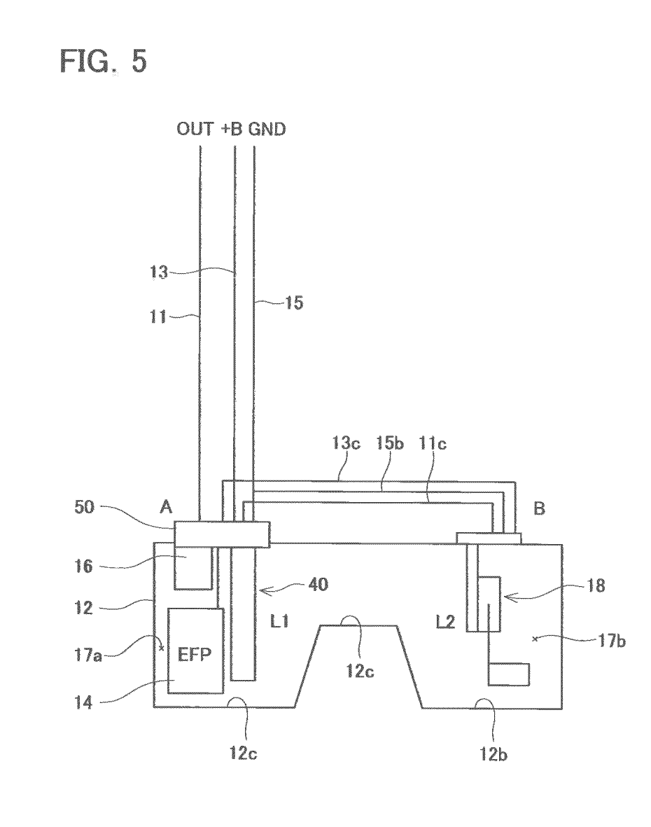

Still alternatively, a system of measuring properties of fuel as shown in FIG. 5 may be employed in which a liquid level sensor of a capacitance type is used for a measuring device 40 for measuring a liquid level of the first fuel chamber 17a, and on the other hand, a sender gage 18 for detecting a liquid level by a rotation angle of an arm to which a float is connected is used for the measuring device 18 for measuring a liquid level in the second fuel chamber 17b. Also in this case, signals from the respective measuring devices 16, 40, and 18 are input to a tank ECU 50, and processing similar to the above embodiment is performed in the tank ECU 50.

Note that, in the above each embodiment, the communication between the tank ECU and the engine ECU is performed via the signal line 11, but the communication between the tank ECU and the engine ECU may be wirelessly performed.

Furthermore, in the above each embodiment, the fuel properties (that is, liquid quality of fuel (for example, concentration of ethanol in fuel), fuel temperature, fuel storage quantity) are specified by the tank ECU, and the specified fuel properties are output to the engine ECU, but the technique disclosed in the specification is not limited to such a configuration. For example, respective results detected by the fuel property measuring device 16, the first liquid level measuring device 18a, and the second liquid level measuring device 18b may be output to the engine ECU from the tank ECU without processing. In this ease, the engine ECU may specify properties of fuel (that is, liquid quality of fuel (for example, concentration of ethanol in the fuel), fuel temperature, fuel storage quantity) based on the respective results detected by the fuel property measuring device 16, the first liquid level measuring device 18a, and the second liquid level measuring device 18b. Alternatively, the tank ECU may output to the engine ECU both of the results detected by respective measuring devices and properties of fuel obtained by processing the detected results.

While specific examples of the present invention have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present invention is not limited to the combinations described at the time the claims are filed. Further, the purpose of the examples illustrated by the present description or drawings is to satisfy multiple objectives simultaneously, and satisfying any one of those objectives gives technical utility to the present invention.

What is claimed is:

1. A system configured to measure properties of fuel in a fuel tank, the system comprising:
a first measuring device configured to measure a first property of the fuel in the fuel tank;
a second measuring device configured to measure a second property of the fuel in the fuel tank; and
a processor connected to the first and second measuring devices, and configured capable of communicating with a control device that controls an internal combustion engine to which the fuel in the fuel tank is supplied, wherein the processor outputs first signals, a second signal, or both the first and second signals, the first signals indicating a first result measured by the first measuring device and a second result measured by the second measuring device, and the second signal being obtained by processing the first and second results.

2. The system according to claim 1, wherein the processor converts the first result inputted by the first measuring device and the second result inputted by the second measuring device to serial signals, and outputs the serial signals to the control device.

3. The system according to claim 2, wherein
the processor comprises a power control unit adapted to connect to an external power source, and
the power control unit controls power supplied from the external power source according to an order from the control device, and supplies the controlled power to a fuel pump.

4. The system according to claim 3, wherein the processor further comprises a power unit configured to supply the power supplied from the external power source to the first and second measuring devices.

5. The system according to claim 4, wherein
the first measuring device is disposed at a first position in the fuel tank,
the second measuring device is disposed at a second position in the fuel tank,
the first and second properties are a same property, and
the processor determines based on the first result inputted by the first measuring device and the second result inputted by the second measuring device whether one of or both of the first and second measuring devices are operating abnormally or not.

6. The system according to claim 5, wherein
the processor corrects one of or both of the first and second results based on the first result inputted by the first measuring device and the second result inputted by the second measuring device.

7. The system according to claim 6, wherein
the processor is disposed at a third position of the fuel tank, the third position being different from the first and second positions, and
the processor is connected to each of the first and second measuring devices via a drive shield line.

8. The system according to claim 1, wherein
the first measuring device is disposed at a first position in the fuel tank,
the second measuring device is disposed at a second position in the fuel tank,
the first and second properties are a same property, and
the processor determines based on the first result inputted by the first measuring device and the second result inputted by the second measuring device whether one of or both of the first and second measuring devices are operating abnormally or not.

9. The system according to claim 8, wherein
the processor corrects one of or both of the first and second results based on the first result inputted by the first measuring device and the second result inputted by the second measuring device.

10. The system according to claim 1, wherein
the processor is disposed at a predetermined position of the fuel tank,
one of or both of the first and second measuring devices are disposed at positions different from the predetermined position, and
the processor is connected to the one of or both of the first and second measuring devices disposed at the different positions via a drive shield line.

11. A system configured to measure properties of fuel in a fuel tank, the system comprising:
a first measuring device configured to measure a first property of the fuel in the fuel tank;
a second measuring device configured to measure a second property of the fuel in the fuel tank, wherein the first and second properties are a same property; and
a processor connected to the first and second measuring devices, the processor configured to determine based on the first result inputted by the first measuring device and the second result inputted by the second measuring device whether one of or both of the first and second measuring devices are operating abnormally or not.

12. The system according to claim 11, wherein
the processor corrects one of or both of the first and second results based on the first result inputted by the first measuring device and the second result inputted by the second measuring device.
